(19) United States
(12) Patent Application Publication
(10) Pub. No.: US 2024/0166074 A1
(43) Pub. Date: May 23, 2024

(54) INFORMATION MANAGER, INFORMATION MANAGEMENT SYSTEM, AND INFORMATION MANAGEMENT METHOD

(71) Applicant: TOYOTA JIDOSHA KABUSHIKI KAISHA, Toyota-shi (JP)

(72) Inventors: Makoto KAKUCHI, Toyota-shi (JP); Yurika TANAKA, Yokosuka-shi (JP); Kazuya TSUCHIYA, Toyota-shi (JP); Daisuke TSUTSUMI, Nagoya-shi (JP); Hiroaki SUGIYAMA, Nagoya-shi (JP)

(73) Assignee: TOYOTA JIDOSHA KABUSHIKI KAISHA, Toyota-shi (JP)

(21) Appl. No.: 18/510,275

(22) Filed: Nov. 15, 2023

(30) Foreign Application Priority Data
Nov. 17, 2022 (JP) 2022-184239

(51) Int. Cl. B60L 53/64; B60L 58/12

(52) U.S. Cl. CPC B60L 53/64; B60L 58/12

(57) ABSTRACT

A management server performs processing including registering reservation information when it accepts the reservation information, when a period of use covers all time frames of a DR request, when an intention to participate in DR is indicated, and when a reservation can be made, canceling a tentative reservation when the reservation cannot be made but when a reservation can be made in a tentative reservation time slot, and registering tentative reservation information when the intention to participate in DR is not indicated and when a reservation can be made.

### CROSS REFERENCE TO RELATED APPLICATIONS

This nonprovisional application is based on Japanese Patent Application No. 2022-184239 filed with the Japan Patent Office on Nov. 17, 2022, the entire contents of which are hereby incorporated by reference.

### BACKGROUND

### Field

The present disclosure relates to an information manager.

### Description of the Background Art

By renting a parking space in a parking lot where a charging apparatus is provided to allow parking of a vehicle on which a power storage is mounted, the power storage can be charged while an electrically powered vehicle is parked in the parking space. For such a service for rental of the parking space on a chargeable basis, for example, a technique to set a parking fee in accordance with an amount of charging power to the power storage has been known.

For example, Japanese Patent Laying-Open No. 2014-191356 describes a parking lot charging authentication system and a parking lot charging authentication method that allow selection as appropriate of an available parking spot equipped with a charging apparatus at a desired location for facilitated charging and allow charging of a use fee based on a pricing system in accordance with an amount of charging power.

### SUMMARY

Use of the power storage mounted on the electrically powered vehicle parked at a parking space as described above for supply and demand balancing in a power grid can provide appropriate balancing between an amount of demand and an amount of supply of electric power in the power grid. Therefore, in rental of the parking space where the charging apparatus is provided, a contribution to supply and demand balancing can be improved as a proportion of users who participate in supply and demand balancing increases. Increase in proportion of the users who participate in supply and demand balancing among users who rent parking spaces has thus been demanded. In recent years, a user who works remotely in a car while the car is parked at a rental parking space rents the parking space for a relatively long time. Therefore, increase of users who are negative to supply and demand balancing may lead to unsuccessful improvement in contribution to supply and demand balancing.

An object of the present disclosure is to provide an information manager, an information management system, and an information management method that increase users who participate in supply and demand balancing in a power grid among users who rent parking spaces where electric power can be supplied and received to and from the power grid.

An information manager according to one aspect of the present disclosure is an information manager that manages information on a use reservation to use a charging and discharging stand that is connected to a power grid and charges and discharges a power storage mounted on a vehicle. This information manager includes a communication apparatus that receives from a terminal used for the use reservation, request information and permission and rejection information, the request information requesting the use reservation for a reservation target period, the permission and rejection information indicating permission or rejection of participation into supply and demand balancing in the power grid, of the vehicle in use of the charging and discharging stand and a controller that performs reservation processing for making the use reservation in accordance with the request information when participation of the vehicle into the supply and demand balancing is permitted. The controller obtains a state of charge (SOC) of the power storage and uses the obtained SOC to set an amount of charging and discharging and a period of charging and discharging of the vehicle during a period during which the supply and demand balancing is performed.

Since the reservation processing is thus performed for the vehicle permitted to participate in supply and demand balancing, users who participate in supply and demand balancing can be increased. Furthermore, when supply and demand balancing is performed during the reservation target period, the power storage mounted on the vehicle can be used for supply and demand balancing. Therefore, contribution to electric power supply and demand balancing in the power grid can be made.

In one embodiment, when the participation into the supply and demand balancing is not permitted, the controller performs provisional reservation processing for provisionally making the use reservation in accordance with the request information. When the controller receives other request information with permission of the participation into the supply and demand balancing after the controller performs the provisional reservation processing, the controller cancels a provisional reservation and performs the reservation processing.

Thus, when participation of the vehicle into supply and demand balancing is not permitted, provisional reservation processing is performed. When other request information with permission of participation in supply and demand balancing is later accepted, the reservation is canceled and hence users who participate in supply and demand balancing can be increased.

Furthermore, in one embodiment, the controller obtains identification information for identification of the vehicle and uses a history of participation into the supply and demand balancing and a history of permission of the participation specified by the identification information to permit participation into the supply and demand balancing, and when the number of times of non-participation into the supply and demand balancing is equal to or larger than a predetermined number of times, the controller determines that the participation into the supply and demand balancing is not permitted.

Thus, provisional reservation processing is performed for a use reservation which is highly likely to result in non-participation in supply and demand balancing also next time. Therefore, a room for a subsequent reservation in accordance with other request information with permission of participation into supply and demand balancing can be left. Therefore, users who participate in supply and demand balancing can be increased.

Furthermore, in one embodiment, when the target period and the period during which the supply and demand balancing is performed overlap with each other after the controller performs the reservation processing, the controller notifies the terminal of information indicating that the vehicle is going to participate in the supply and demand balancing.

Since use of the charging and discharging stand during the reservation target period can thus be encouraged, the charging and discharging stand is used in accordance with the reservation so that supply and demand balancing can appropriately be performed.

An information management system according to another aspect of the present disclosure is an information management system that manages information on a use reservation to use a charging and discharging stand connected to a power grid. This information management system includes a vehicle on which a power storage is mounted, the power storage being charged and discharged by using the charging and discharging stand, a terminal used for the use reservation, and a server that communicates with the terminal. The server receives from the terminal, request information and permission and rejection information, the request information requesting the use reservation for a reservation target period, the permission and rejection information indicating permission or rejection of participation into supply and demand balancing in the power grid, of the vehicle in use of the charging and discharging stand. The server performs reservation processing for making the use reservation in accordance with the request information when participation of the vehicle into the supply and demand balancing is permitted. The server obtains an SOC of the power storage and uses the obtained SOC to set an amount of charging and discharging and a period of charging and discharging of the vehicle during a period during which the supply and demand balancing is performed.

An information management method according to yet another aspect of the present disclosure is an information management method of managing information on a use reservation to use a charging and discharging stand that is connected to a power grid and charges and discharges a power storage mounted on a vehicle. This information management method includes receiving from a terminal used for the use reservation, request information and permission and rejection information, the request information requesting the use reservation for a reservation target period, the permission and rejection information indicating permission or rejection of participation into supply and demand balancing in the power grid, of the vehicle in use of the charging and discharging stand, performing reservation processing for making the use reservation in accordance with the request information when participation of the vehicle into the supply and demand balancing is permitted, and obtaining an SOC of the power storage and using the obtained SOC to set an amount of charging and discharging and a period of charging and discharging of the vehicle during a period during which the supply and demand balancing is performed.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram for illustrating an exemplary configuration of an information management system.

FIG. 2 is a diagram for illustrating use of a charging and discharging stand provided in a parking lot.

FIG. 3 is a flowchart showing exemplary reservation processing performed by a management server.

FIG. 4 is a flowchart showing exemplary processing for supply and demand balancing performed by the management server.

### DESCRIPTION OF THE PREFERRED EMBODIMENTS

An embodiment of the present disclosure will be described in detail below with reference to the drawings. The same or corresponding elements in the drawings have the same reference characters allotted and description thereof will not be repeated.

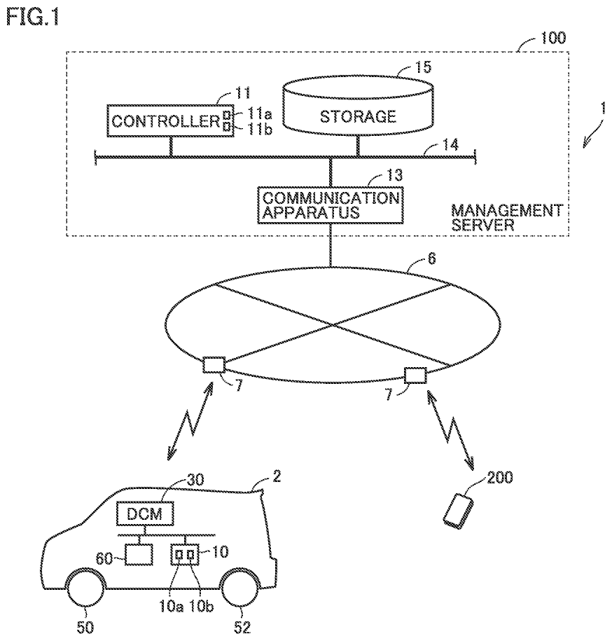

FIG. 1 is a diagram for illustrating an exemplary configuration of an information management system 1. As shown in FIG. 1, in the present embodiment, information management system 1 includes a vehicle 2, a communication network 6, a base station 7, a management server 100, and a terminal 200.

Vehicle 2 may be, for example, a vehicle including an engine as a drive source, a battery electric vehicle including a motor as a drive source, or a hybrid electric vehicle incorporating an engine and a motor at least one of which is employed as a drive source. Though FIG. 1 shows only a single vehicle 2 for the sake of convenience of description, the number of vehicles is not particularly limited to one, and two or more vehicles may be provided.

Information management system 1 is configured to obtain predetermined information from vehicle 2 or terminal 200 configured to communicate with management server 100 or provide such information thereto, so as to manage the obtained or provided information.

Management server 100 includes a controller 11, a communication apparatus 13, and a storage 15. Controller 11, communication apparatus 13, and storage 15 are communicatively connected to one another through a communication bus 14.

Controller 11 includes a processor 11a that executes a program, such as a central processing unit (CPU), a memory (a read only memory (ROM), a random access memory (RAM), and the like) 11b, and an input and output port (not shown) for input and output of various signals. Various types of control by controller 11 are carried out by software processing, that is, reading of a program stored in memory 11b by CPU 11a. The various types of control by controller 11 can be carried out also by execution by a general-purpose computer (not shown), of a program stored in a storage medium. The various types of control by controller 11 may be processed by dedicated hardware (electronic circuitry) without being limited to software processing.

Information on a use reservation to use a charging and discharging stand which will be described later is stored in storage 15. The predetermined information is, for example, information for specifying vehicle 2 (which will be described as a vehicle ID below), a history of use of the charging and discharging stand (which will be described later) by vehicle 2, a history of reservations made by vehicle 2, and information relating to the reservations by vehicle 2. The vehicle ID is specific information set for each vehicle. Management server 100 can specify a sender vehicle or a destination vehicle based on the vehicle ID.

Communication apparatus 13 establishes bidirectional communication between controller 11 and communication network 6. Management server 100 allows communication with vehicle 2 on which a DCM 30 is mounted with the use of communication apparatus 13 through base station 7 provided on communication network 6. Furthermore, management server 100 allows communication with terminal 200 with the use of communication apparatus 13 through base station 7 provided on the communication network.

Terminal 200 is, for example, a portable terminal such as a smartphone, a tablet terminal, or a wearable device owned by a user of vehicle 2. Terminal 200 is a computer including a processor that executes a program, such as a CPU, a memory, and an input and output interface that are not shown. Terminal 200 is configured to communicate with management server 100 through base station 7. For example, terminal 200 and the vehicle ID of vehicle 2 are stored in correspondence with each other in management server 100.

A specific configuration of vehicle 2 will now be described. Vehicle 2 includes a drive wheel 50 and a driven wheel 52. As drive wheel 50 is rotated by an operation of the drive source, drive force is applied to vehicle 2 and vehicle 2 travels.

Vehicle 2 further includes an electronic control unit (ECU) 10, a data communication module (DCM) 30, and a navigation system 60.

ECU 10 is a computer including a processor 10a that executes a program, such as a CPU, a memory 10b, and an input and output interface (not shown). ECU 10 includes various control programs for control of various actuators mounted on vehicle 2. The various control programs include at least one control program, for example, for steering control, drive control, and braking control. The various control programs may include, for example, a program for execution of various drive assistance systems that perform functions relating to assistance of drive of vehicle 2.

DCM 30 is a communication module configured to establish bidirectional communication with management server 100 through communication network 6 and base station 7.

Navigation system 60 includes, for example, a position detector that detects a position with the use of a global positioning system (GPS) satellite, a wireless local area network (LAN), or the like, a database where map information is stored, and a controller including a CPU or the like (none of which is shown). The position detector specifies a position of vehicle 2. Navigation system 60 specifies a travel route on a map from a current position to a destination of vehicle 2 or guides vehicle 2 that travels along a travel route to a destination. Navigation system 60 has map information or guidance information shown on a not-shown touch panel display, specifies a destination inputted by a driver/passenger by an operation onto a touch panel thereby, or shows options of a plurality of travel routes to the specified destination.

On vehicle 2 as described above, a power storage 20 is mounted. When vehicle 2 is parked at a parking space in a parking lot where charging and discharging stand 300 is provided, power storage 20 can be charged during parking of vehicle 2.

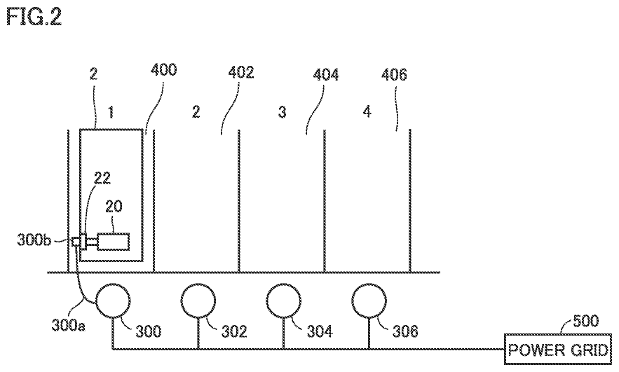

FIG. 2 is a diagram for illustrating use of a charging and discharging stand provided in a parking lot. As shown in FIG. 2, for example, an example in which parking spaces 400, 402, 404, and 406 are set in a parking lot and charging and discharging stands 300, 302, 304, and 306 corresponding to respective parking spaces 400, 402, 404, and 406 are provided is assumed. Parking spaces 400, 402, 404, and 406 are rented, and a vehicle that rents the parking space is allowed to use the corresponding charging and discharging stand after it is parked. Use or a period of use of the parking space can be reserved, for example, through terminal 200 or the like.

Management server 100 manages reservation information on a reservation made through terminal 200 or the like. An exemplary reservation method will be described later.

For example, a user of vehicle 2 makes a reservation to use parking space 400 through terminal 200, parks vehicle 2 at parking space 400 during a reserved period, and is allowed to use charging and discharging stand 300. Though an example in which management server 100 and terminal 200 are used to make a use reservation to use vehicle 2 will be described by way of example in the description below, a use reservation to use another vehicle can also similarly be made with the use of management server 100 and a not-shown another terminal.

As shown in FIG. 2, vehicle 2 further includes power storage 20 and an inlet 22. Power storage 20 may be, for example, a direct-current (DC) power supply such as a lithium ion battery containing a solid or liquid electrolyte, a nickel metal hydride battery, or various capacitors. Power storage 20 is connected to inlet 22. Inlet 22 is in a shape that allows connection to a connector 300b provided at an end of a cable 300a of charging and discharging stand 300.

When connector 300b is attached to inlet 22, electric power can be supplied and received between power storage 20 and charging and discharging stand 300. For example, as electric power is supplied from charging and discharging stand 300 to power storage 20, power storage 20 can be charged during parking of vehicle 2. By moving vehicle 2 that has been parked from parking space 400 by the time of expiration of the reserved period of use, the user quits use of charging and discharging stand 300 and a parking fee is set in accordance with the period of use, an amount of charging to power storage 20 during parking, or the like.

Use of the power storage mounted on the electrically powered vehicle parked at a parking space as described above for supply and demand balancing in a power grid 500 connected to the charging and discharging stand can provide appropriate balancing between an amount of demand and an amount of supply of electric power in the power grid. Exemplary supply and demand balancing will be described later. Therefore, in rental of the parking space where the charging and discharging stand is provided, a contribution to supply and demand balancing can be improved as a proportion of users who participate in supply and demand balancing increases. Increase in proportion of the users who participate in supply and demand balancing among users who rent parking spaces has thus been demanded. In recent years, a user who works remotely in a car while the car is parked at a rental parking space rents the parking space for a relatively long time. Therefore, increase of users who are negative to supply and demand balancing may lead to unsuccessful improvement in contribution to supply and demand balancing.

In the present embodiment, management server 100 is assumed to perform operations as below. Specifically, management server 100 receives from terminal 200 used for a use reservation, request information that requests the use reservation for a reservation target period and permission and rejection information indicating permission or rejection of participation into supply and demand balancing in power grid 500, of the vehicle in use of the charging and discharging stand. When participation of the vehicle in supply and demand balancing is permitted, management server 100 performs reservation processing for making the use reservation in accordance with the request information. Management server 100 obtains a state of charge (SOC) of power storage 20 and uses the obtained SOC to set an amount of charging and discharging and a period of charging and discharging of the vehicle during a period during which supply and demand balancing is performed. In the present embodiment, management server 100 corresponds to the “information manager.”

Since the reservation processing is thus performed for the vehicle permitted to participate in supply and demand balancing, users who participate in supply and demand balancing can be increased. Furthermore, when supply and demand balancing is performed during the reservation target period, the power storage mounted on the vehicle can be used for supply and demand balancing. Therefore, contribution to electric power supply and demand balancing in the power grid can be made.

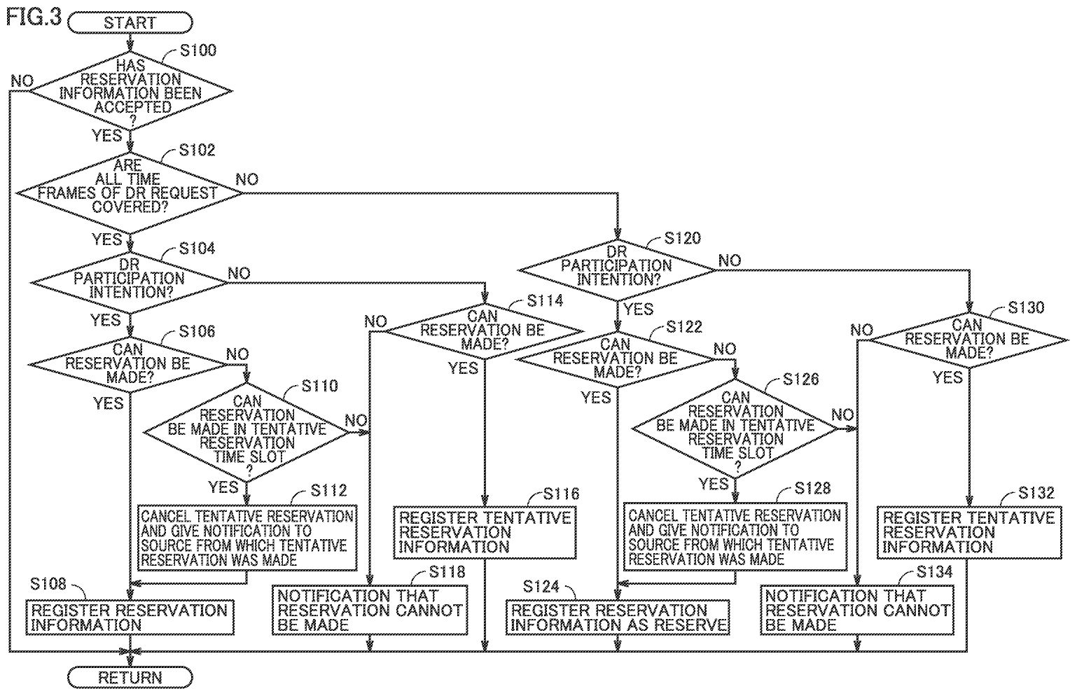

Exemplary reservation processing performed by management server 100 (specifically, controller 11) will be described below with reference to FIG. 3. FIG. 3 is a flowchart showing exemplary reservation processing performed by management server 100. The processing shown in this flowchart is repeatedly performed by controller 11 of management server 100 every prescribed control cycle.

In step (the step being denoted as S below) 100, management server 100 determines whether or not it has accepted reservation information. For example, when management server 100 receives reservation information from terminal 200, it determines that it has accepted the reservation information. For example, the user starts up on terminal 200, a reservation application for making a reservation of charging and discharging stand 300 and inputs the predetermined information on a touch panel or the like. Terminal 200 uses the inputted information to generate reservation information, and transmits the generated reservation information to management server 100. The reservation information may include, for example, in a header or the like of data, information indicating that the information is the reservation information. The reservation information includes, for example, time of start and end of a desired period of use, information (permission and rejection information) indicating an intention to participate in a demand response (DR) request which will be described later, and information indicating that charging and discharging stand 300 is to be reserved. In the present embodiment, management server 100 is assumed, for example, as managing a status of a use reservation for each of a plurality of charging and discharging stands, and an example in which use of charging and discharging stand 300 and parking space 400 is to be reserved in this processing will be described by way of example. When it is determined that the reservation information has been accepted (YES in step S100), the process proceeds to S102.

In S102, management server 100 determines whether or not the desired period of use covers all time frames of a DR request. When time frames of the DR request during the desired period of use are unknown, it is determined that the desired period of use does not cover all time frames of the DR request. Furthermore, when the desired period of use overlaps only with a partial period of the time frames of the DR request as well, it is determined that the period of use does not cover all time frames of the DR request. When the desired period of use is determined as covering all time frames of the DR request (YES in S102), the process proceeds to S104.

In S104, management server 100 determines whether or not an intention to participate in the DR request (which may be denoted as a DR participation intention below) is indicated. Management server 100 determines whether or not the DR participation intention has been indicated based on the permission and rejection information included in the reservation information. The permission and rejection information includes, for example, information indicating whether or not to permit participation in the DR request. When it is determined that the DR participation intention has been indicated (YES in step S104), the process proceeds to S106 In S106, management server 100 determines whether or not a reservation based on the received reservation information can be made. For example, when the desired period of use does not overlap with another reserved period inclusive of a tentative reservation time slot, management server 100 determines that the reservation can be made. In the present embodiment, an example in which management server 100 determines whether or not a reservation of charging and discharging stand 300 can be made is described by way of example. When the desired period of use overlaps with another reserved period, management server 100 determines that the reservation cannot be made. When it is determined that the reservation can be made (YES in S106), the process proceeds to S108.

In S108, management server 100 registers the received reservation information. Management server 100 has the following stored in storage 15 in association: information for identification of terminal 200; the period of use; information on whether or not the DR participation intention has been indicated; and information indicating that use of charging and discharging stand 300 is to be reserved. Management server 100 gives to terminal 200 from which the reservation was made, for example, a notification indicating registration of the reservation information. The notification may be given, for example, by representation of text information or images indicating registration of the reservation information on a screen. This processing for registration of the reservation information corresponds to reservation processing. This process thereafter ends. When it is determined that the reservation cannot be made (NO in S106), the process proceeds to S110.

In S110, management server 100 determines whether or not a reservation in the tentative reservation time slot can be made. For example, when the desired period of use overlaps with a tentatively reserved period of use and does not overlap with another reserved period, management server 100 determines that the reservation in the tentative reservation time slot can be made. When it is determined that the reservation in the tentative reservation time slot can be made (YES in S110), the process proceeds to S112.

In S112, management server 100 cancels the tentative reservation that overlaps with the desired period of use and gives a notification of cancellation of the tentative reservation to the terminal from which the tentative reservation was made. Since a notification method is similar to the notification method described in connection with the processing in S108, detailed description thereof will not be repeated. Thereafter, the process proceeds to S108. When it is determined that the DR participation intention has not been indicated (NO in S104), the process proceeds to S114.

In S114, management server 100 determines whether or not a reservation based on the received reservation information can be made. Since a determination method is similar to the determination method described in connection with the processing in S106, detailed description thereof will not be repeated. When it is determined that the reservation can be made (YES in S114), the process proceeds to S116.

In S116, management server 100 registers tentative reservation information based on the received reservation information. Management server 100 has the following stored in storage 15 in association: information for identification of terminal 200; the period of use; information on whether or not the DR participation intention has been indicated; information indicating that use of charging and discharging stand 300 is to be reserved; and information indicating that the reservation is tentative. The tentative reservation refers to a provisional use reservation, and registration of this tentative reservation information corresponds to provisional reservation processing. Thereafter, this process ends. When it is determined that the reservation in the tentative reservation time slot cannot be made (NO in S110) or when it is determined that the reservation cannot be made (NO in S114), the process proceeds to S118.

In S118, management server 100 notifies terminal 200 of information indicating that the reservation cannot be made. Since a notification method is similar to the notification method described in connection with the processing in S108, detailed description thereof will not be repeated. Thereafter, this process ends. When it is determined that the desired period of use does not cover all time frames of the DR request (NO in S102), the process proceeds to S120.

In S120, management server 100 determines whether or not the DR participation intention has been indicated. Since a method of determining whether or not the DR participation intention has been indicated is similar to the determination method described in connection with the processing in S104, detailed description thereof will not be repeated. When it is determined that the DR participation intention has been indicated (YES in S120), the process proceeds to S122.

In S122, management server 100 determines whether or not a reservation based on the received reservation information can be made. Since a determination method is similar to the determination method described in connection with the processing in S106, detailed description thereof will not be repeated. When it is determined that the reservation can be made (YES in S122), the process proceeds to S124.

In S124, management server 100 registers the reservation information as reserve for supply and demand balancing. For example, management server 100 has the following stored in storage 15 in association: information for identification of terminal 200; the period of use; information on whether or not the DR participation intention has been indicated; information indicating that use of charging and discharging stand 300 is to be reserved; and information indicating that a vehicle corresponding to the reservation information is reserve for supply and demand balancing. For example, when the reserved period of use is found to overlap with a time frame of the DR request after the reservation is made, management server 100 sets vehicle 2 to be connected to charging and discharging stand 300 during the period of use as a candidate to be selected as a participating vehicle in response to the DR request. Management server 100 gives to terminal 200 from which the reservation was made, for example, a notification indicating registration of the reservation information as reserve. Since a notification method is similar to the notification method described in connection with the processing in S108, detailed description thereof will not be repeated. Thereafter, this process ends. When it is determined that the reservation cannot be made (NO in S122), the process proceeds to S126.

In S126, management server 100 determines whether or not the reservation in the tentative reservation time slot can be made. Since a determination method is similar to the determination method described in connection with the processing in S110, detailed description thereof will not be repeated. When it is determined that the reservation in the tentative reservation time slot can be made (YES in S126), the process proceeds to S128.

In S128, management server 100 cancels the tentative reservation that overlaps with the desired period of use and gives a notification indicating cancellation of the tentative reservation to the terminal from which the tentative reservation was made. Since a notification method is similar to the notification method described in connection with the processing in S108, detailed description thereof will not be repeated. Thereafter, the process proceeds to S124. When it is determined in S120 that the DR participation intention has not been indicated (NO in S120), the process proceeds to S130.

In S130, management server 100 determines whether or not a reservation based on the received reservation information can be made. Since a determination method is similar to the determination method described in connection with the processing in S106, detailed description thereof will not be repeated. When it is determined that the reservation can be made (YES in S130), the process proceeds to S132.

In S132, management server 100 registers tentative reservation information based on the received reservation information. Since a registration method is similar to the registration method described in connection with the processing in S116, detailed description thereof will not be repeated. Thereafter, this process ends. When it is determined that the reservation in the tentative reservation time slot cannot be made (NO in S126) or when it is determined in S130 that the reservation cannot be made (NO in S130), the process proceeds to S134.

In S134, management server 100 notifies terminal 200 of information indicating that the reservation cannot be made. Since a notification method is similar to the notification method described in connection with S108, detailed description thereof will not be repeated. Thereafter, this process ends.

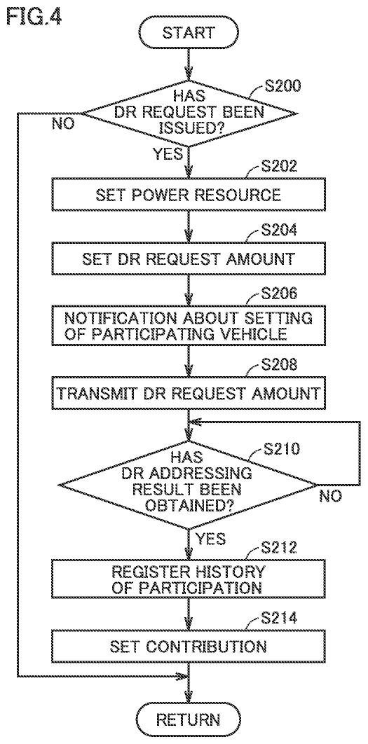

Exemplary processing for supply and demand balancing performed by management server 100 (specifically, controller 11) will now be described with reference to FIG. 4. FIG. 4 is a flowchart showing exemplary processing for supply and demand balancing performed by management server 100. The processing shown in this flowchart is repeatedly performed by controller 11 of management server 100 every prescribed control cycle.

In S200, management server 100 determines whether or not a DR request has been issued. For example, when management server 100 receives a signal indicating the DR request from an aggregator server (not shown) that totally manages energy of the power grid, it determines that the DR request has been issued. When it is determined that the DR request has been issued (YES in S200), the process proceeds to S202.

In S202, management server 100 sets a power resource for addressing the DR request. In the present embodiment, management server 100 is assumed to set as the power resource, for example, an electrically powered vehicle, the reservation information from which is set to indicate the DR participation intention, among electrically powered vehicles that have made reservations to use charging and discharging stands 300, 302, 304, and 306 in time frames of the DR request. For example, when a request to increase the amount of demand (which is also denoted as a posiwatt DR request below) is issued, management server 100 sets as the power resource, an electrically powered vehicle capable of charging in the time frame of the DR request. For example, when a request to decrease the amount of demand (which is also denoted as a negawatt DR request below) is issued, management server 100 sets as the power resource, an electrically powered vehicle capable of discharging in the time frame of the DR request. Thereafter, the process proceeds to S204.

In S204, management server 100 sets a DR request amount for each of the set power resources. For example, management server 100 uses the current SOC of each of the power resources and a full charge capacity or the like of each of the power resources to set the DR request amount for each of the power resources. Thereafter, the process proceeds to S206.

In S206, management server 100 notifies a terminal brought in correspondence with the vehicle set as the participating vehicle in the time frames of the DR request, of the fact that the vehicle was set as the participating vehicle. The notification may be given, for example, by representation on the screen, of text information or images indicating setting as the participating vehicle in the time frames of the DR request. Thereafter, the process proceeds to S208.

In S208, management server 100 transmits a signal including information on the set DR request amount to the set power resource. Thereafter, the process proceeds to S210.

In S210, management server 100 determines whether or not it has obtained a DR addressing result from the set power resource. The power resource transmits an amount of charging and discharging in the time frames of the DR request to management server 100 when the time frames of the DR request elapse. When management server 100 receives the amount of charging and discharging in the time frames of the DR request from the power resource, it determines that it has obtained the DR addressing result. When the management server determines that it has obtained the DR addressing result (YES in S210), the process proceeds to S212. When the management server determines that it has not obtained the DR addressing result (NO in S210), the process returns to S210.

In S212, management server 100 registers a history of participation of the vehicle set as the power resource. Management server 100 has the vehicle ID, the reservation information, and information indicating participation of the vehicle in response to the DR request stored in storage 15 in association. Thereafter, the process proceeds to S214.

In S214, management server 100 sets a contribution. Management server 100 sets the contribution, for example, based on the amount of charging and discharging in the time frames of the DR request. The contribution is used, for example, for discount or the like of the parking fee. Thereafter, the process ends. When it is determined that the DR request has not been issued (NO in S200), this process ends.

An operation by management server 100 based on the structure and the flowchart as above will be described. For example, an example in which the user operates terminal 200 in an attempt to reserve use of charging and discharging stand 300 in a desired time frame is assumed. Furthermore, an example in which the time frame of the DR request is unknown is assumed.

When the user inputs the time of start and end of a use reservation to terminal 200 and inputs information indicating permission of participation in DR to terminal 200, the reservation information including the time of start and end, the permission and rejection information, and information indicating that charging and discharging stand 300 is to be reserved is transmitted to management server 100.

When management server 100 accepts the reservation information (YES in S100) but when the time frame of the DR request is unknown (NO in S102), whether or not the DR participation intention has been indicated is determined (S120).

When it is determined that the DR participation intention has been indicated based on the permission and rejection information (YES in S120) and when there is an available period of use in a desired period of use (YES in S122), reservation information is registered as reserve in case of reception of the DR request (S124).

In this case, when management server 100 receives the DR request (YES in S200), the power resource is set (S202). When the time frame of the DR request is included in the reserved period of use of vehicle 2, vehicle 2 is set as a candidate to be selected for the participating vehicle. When vehicle 2 is set as the participating vehicle, the DR request amount for vehicle 2 is set (S204), and information indicating that the vehicle is set as the participating vehicle is given to terminal 200 (S206). A signal including the information on the set DR request amount is transmitted to vehicle 2 (S208).

When the user moves vehicle 2 to parking space 400 and connects vehicle 2 to charging and discharging stand 300 during the reserved period of use, vehicle 2 performs an operation corresponding to the DR request which is either charging or discharging in the time frame of the DR request. Vehicle 2 performs the operation corresponding to the DR request, and thereafter transmits the amount of charging and discharging in the time frame of the DR request to management server 100. When management server 100 obtains the amount of charging and discharging in the time frame of the DR request (YES in S210), it registers the history of participation in association with the vehicle ID (S212) and sets the contribution (S214).

When the user inputs the time of start and end of the use reservation to terminal 200 and inputs information indicating non-permission of participation into DR to terminal 200, the reservation information including the time of start and end, the permission and rejection information, and information indicating that charging and discharging stand 300 is to be reserved is transmitted to management server 100.

When management server 100 accepts the reservation information (YES in S100), when the time frame of the DR request is unknown (NO in S102), when it is determined that the DR participation intention has not been indicated (NO in S120), and when there is an available period of use in a desired period of use (YES in S130), the tentative reservation information is registered based on the reservation information (S132).

In this case, when the reservation information in which the same period of use is desired is subsequently accepted from another terminal (YES in S100), when the time frame of the DR request is unknown (NO in S102), and when it is determined that the DR participation intention has been indicated (YES in S120), it is determined that the reservation cannot be made (NO in S122) because tentative reservation for the same period of use has been made. When it is determined that the reservation in the tentative reservation time slot can be made (YES in S126), the previous tentative reservation is canceled and information indicating cancellation is given to terminal 200 of the user who made the tentative reservation (S128). The reservation information received from another terminal that indicates the DR participation intention is then registered as reserve (S124).

As set forth above, according to the information manager according to the present embodiment, the reservation processing is performed for the vehicle permitted to participate in supply and demand balancing, and hence users who participate in supply and demand balancing can be increased. Furthermore, when supply and demand balancing is performed during the reservation target period, the power storage mounted on the vehicle can be used for supply and demand balancing, which can contribute to electric power supply and demand balancing in the power grid. When participation of the vehicle in supply and demand balancing is not permitted, provisional reservation processing is performed. Therefore, when other request information with permission of participation in supply and demand balancing is subsequently accepted, the reservation is canceled and hence users who participate in supply and demand balancing can be increased. Therefore, the information manager, the information management system, and the information management method that increase users who participate in supply and demand balancing in the power grid among users who rent parking spaces where electric power can be supplied and received to and from the power grid can be provided.

The reservation can be ensured, with permission of participation in supply and demand balancing being defined as a condition. Therefore, a provider of the parking space benefits from contribution to supply and demand balancing, and a service highly convenient for a user who remotely works in a car for a relatively long time can also be provided.

A modification will be described below.

Though an example in which processing is performed with the use of a single processor 11a and a single memory 11b in controller 11 of management server 100 is described in the embodiment above by way of example, the processing in the flowcharts shown in FIGS. 3 and 4 may be performed by reading and execution by at least one processor, of a program stored in at least one memory.

Though reservation of charging and discharging stand 300 is described in the embodiment above, management server 100 may allocate in accordance with a predetermined priority, a charging and discharging stand among a plurality of charging and discharging stands 300, 302, 304, and 306 that is available during a desired period of use. The priority may be predetermined, for example, in such a manner that a charging and discharging stand lower in frequency of use is higher in priority than a charging and discharging stand higher in frequency of use or a charging and discharging stand shorter in period of use is higher in priority than a charging and discharging stand longer in period of use. Management server 100 may allocate charging and discharging stands available during the desired period of use, inclusive of a plurality of charging and discharging stands in another parking lot, in addition to the plurality of charging and discharging stands 300, 302, 304, and 306 provided in one parking lot. Management server 100 may give, for example, information on a position of the allocated charging and discharging stand to the terminal, together with a notification indicating completion of registration.

An example in which the reservation is assured when it is determined that the DR participation intention has been indicated is described in the embodiment above by way of example. When permission and rejection information indicating the DR participation intention is received as well, the history of participation in the DR request and the history of permission of participation in the DR request brought in correspondence with the vehicle ID may be read from storage 15 and participation in supply and demand balancing is permitted. Meanwhile, when the number of times of non-participation in supply and demand balancing is equal to or larger than a predetermined number of times, it may be determined that the DR participation intention has not been indicated and the tentative reservation information based on the reservation information may be registered.

Thus, provisional reservation processing is performed for a use reservation which is highly likely to result in non-participation in supply and demand balancing also next time so that a room for a subsequent reservation in accordance with other request information with permission of participation into supply and demand balancing can be left. Therefore, users who participate in supply and demand balancing can be increased.

The embodiment above describes that presence of the intention to participate in DR is more advantageous in setting of a condition for facilitation of an assured use reservation than absence of the intention to participate in DR. In addition to facilitation of an assured reservation, such an advantageous condition as setting of a greater discount in the presence of the intention to participate in DR than in the absence of the intention to participate in DR or grant of a coupon only in the presence of the intention to participate in DR may be set.

Though an example in which the reservation is assured in both of a case in which the reserved period of use covers all time frames of a DR request and a case in which the reserved period of use covers a part of the time frames of the DR request is described in the embodiment above by way of example, for example, a reservation for a period of use covering all time frames of the DR request may be made preferentially over a reservation for a period of use covering a part of the time frames of the DR request. For example, when a reservation for a period of use that covers all time frames of the DR request and overlaps with a period of use corresponding to an existing reservation is requested while reservation for a period of use covering a part of the time frames of the DR request has been made, management server 100 may cancel the existing reservation.

The entirety or a part of the modifications described above may be carried out as being combined as appropriate.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. An information manager that manages information on a use reservation to use a charging and discharging stand that is connected to a power grid and charges and discharges a power storage mounted on a vehicle, the information manager comprising:
a communication apparatus that receives from a terminal used for the use reservation, request information and permission and rejection information, the request information requesting the use reservation for a reservation target period, the permission and rejection information indicating permission or rejection of participation into supply and demand balancing in the power grid, of the vehicle in use of the charging and discharging stand; and
a controller that performs reservation processing for making the use reservation in accordance with the request information when participation of the vehicle into the supply and demand balancing is permitted, wherein
the controller obtains a state of charge (SOC) of the power storage and uses the obtained SOC to set an amount of charging and discharging and a period of charging and discharging of the vehicle during a period during which the supply and demand balancing is performed.

2. The information manager according to claim 1, wherein
when the participation into the supply and demand balancing is not permitted, the controller performs provisional reservation processing for provisionally making the use reservation in accordance with the request information, and
when the controller receives other request information with permission of the participation into the supply and demand balancing after the controller performs the provisional reservation processing, the controller cancels a provisional reservation and performs the reservation processing.

3. The information manager according to claim 2, wherein
the controller
obtains identification information for identification of the vehicle, and
uses a history of participation into the supply and demand balancing and a history of permission of the participation specified by the identification information to permit participation into the supply and demand balancing, and
when the number of times of non-participation into the supply and demand balancing is equal to or larger than a predetermined number of times, the controller determines that the participation into the supply and demand balancing is not permitted.

4. The information manager according to claim 1, wherein
when the target period and the period during which the supply and demand balancing is performed overlap with each other after the controller performs the reservation processing, the controller notifies the terminal of information indicating that the vehicle is going to participate in the supply and demand balancing.

5. An information management system that manages information on a use reservation to use a charging and discharging stand connected to a power grid, the information management system comprising:
a vehicle on which a power storage is mounted, the power storage being charged and discharged by using the charging and discharging stand;
a terminal used for the use reservation; and
a server that communicates with the terminal, wherein
the server
receives from the terminal, request information and permission and rejection information, the request information requesting the use reservation for a reservation target period, the permission and rejection information indicating permission or rejection of participation into supply and demand balancing in the power grid, of the vehicle in use of the charging and discharging stand,
performs reservation processing for making the use reservation in accordance with the request information when participation of the vehicle into the supply and demand balancing is permitted, and
obtains a state of charge (SOC) of the power storage and uses the obtained SOC to set an amount of charging and discharging and a period of charging and discharging of the vehicle during a period during which the supply and demand balancing is performed.

6. An information management method of managing information on a use reservation to use a charging and discharging stand that is connected to a power grid and charges and discharges a power storage mounted on a vehicle, the information management method comprising:
receiving from a terminal used for the use reservation, request information and permission and rejection information, the request information requesting the use reservation for a reservation target period, the permission and rejection information indicating permission or rejection of participation into supply and demand balancing in the power grid, of the vehicle in use of the charging and discharging stand;
performing reservation processing for making the use reservation in accordance with the request information when participation of the vehicle into the supply and demand balancing is permitted; and
obtaining a state of charge (SOC) of the power storage and using the obtained SOC to set an amount of charging and discharging and a period of charging and discharging of the vehicle during a period during which the supply and demand balancing is performed.
